(19) United States
(12) Patent Application Publication
(10) Pub. No.: US 2022/0187613 A1
(43) Pub. Date: Jun. 16, 2022

(54) DIFFRACTIVE OPTICAL ELEMENT AND DEVICE INCLUDING THE SAME

(71) Applicant: Samsung Electronics Co., Ltd., Suwon-si (KR)

(72) Inventors: Beom Seok KIM, Seoul (KR); Hyun Seok CHOI, Seoul (KR)

(21) Appl. No.: 17/524,710

(22) Filed: Nov. 11, 2021

(30) Foreign Application Priority Data
Dec. 15, 2020 (KR) 10-2020-0175307

(51) Int. Cl. G02B 27/44; G02B 27/42

(52) U.S. Cl. CPC G02B 27/44; G02B 27/4244

(57) ABSTRACT

A diffractive optical element includes a plurality of diffractive layers. The plurality of diffractive layers includes adjacent diffractive layers including a plurality of optical axes that change along in-plane rotation directions opposite to

This application claims priority to Korean Patent Application No. 10-2020-0175307 filed on Dec. 15, 2020, and all the benefits accruing therefrom under 35 U.S.C. § 119, the content of which in its entirety is herein incorporated by reference.

### BACKGROUND

### 1. Field

A diffractive optical element and a device including the diffractive optical element are disclosed.

### 2. Description of the Related Art

In a development of highly integrated optical devices, research is being conducted to develop optical devices having a smaller size and a thinner thickness. Among these, it is desirable to develop diffractive optical elements which use light diffraction phenomena, and which are applied to optical systems such as lenses or prisms.

### SUMMARY

An embodiment provides a diffractive optical element exhibiting improved diffraction efficiency while realizing a high diffraction angle without a decrease in grating period.

Another embodiment provides a device including the diffractive optical element.

In an embodiment, a diffractive optical element includes a plurality of diffractive layers including adjacent diffractive layers having a plurality of optical axes that change along in-plane rotation directions opposite to each other in a grating period.

In an embodiment, the in-plane rotation direction may be an in-plane clockwise direction or an in-plane counterclockwise direction, one of the adjacent diffractive layers may change along the in-plane clockwise direction in the grating period, and a remaining one of the adjacent diffractive layers may change along an in-plane counterclockwise direction in the grating period.

In an embodiment, the plurality of diffractive layers may include a first diffractive layer including a plurality of optical axes that change along a first in-plane rotation direction that is one of an in-plane clockwise direction and an in-plane counterclockwise direction in the grating period, and a second diffractive layer including a plurality of optical axes that change along a second in-plane rotation direction that is a remaining one of the in-plane clockwise direction and the in-plane counterclockwise direction in the grating period, and the first diffractive layer and the second diffractive layer may be stacked adjacent to each other.

In an embodiment, the plurality of diffractive layers may further include a third diffractive layer including a plurality of optical axes that change along the first in-plane rotation direction in the grating period, where the first diffractive layer, the second diffractive layer, and the third diffractive layer may be sequentially stacked adjacent to each other.

In an embodiment, the first diffractive layer is provided in plural and the second diffractive layer is provided in plural, and first diffractive layers and second diffractive layers may be alternately stacked with one another.

In an embodiment, the grating period of the second diffractive layer may be identical to the grating period of the first diffractive layer.

In an embodiment, the optical axis of the first diffractive layer may be constant along the thickness direction, the optical axis of the second diffractive layer may be constant along the thickness direction, and the optical axis of the first diffractive layer and the optical axis of the second diffractive layer overlapped along the thickness direction of the first diffractive layer and the second diffractive layer may be different from each other in at least a portion of each grating period.

In an embodiment, in each grating period, an angle between the optical axis of the first diffractive layer and the optical axis of the second diffractive layer overlapped in the thickness direction of the first diffractive layer and the second diffractive layer may change continuously between about 0 degree and about 180 degrees.

In an embodiment, the grating periods of the plurality of diffractive layers may be identical to each other.

In an embodiment, each of the plurality of diffractive layers may have a grating period of greater than or equal to about 1.7 micrometers (μm).

In an embodiment, each of the diffractive layers may independently include an optically anisotropic medium satisfying one of Relationships 1A to 1E:

Δn₁(450 nanometers(nm))<Δn₁(550 nm)≤Δn₁(650 nm) [Relationship 1A]

Δn₁(450 nm)≤Δn₁(550 nm)<Δn₁(650 nm) [Relationship 1B]

Δn₁(450 nm)=Δn₁(550 nm)=Δn₁(650 nm) [Relationship 1C]

Δn₁(450 nm)≥Δn₁(550 nm)>Δn₁(650 nm) [Relationship 1D]

Δn₁(450 nm)>Δn₁(550 nm)≥Δn₁(650 nm) [Relationship 1E]

where, in Relationships 1A to 1E,

Δn₁ (450 nm) is the birefringence of the optically anisotropic medium at a wavelength of 450 nm,

Δn₁ (550 nm) is the birefringence of the optically anisotropic medium at a wavelength of 550 nm, and

Δn₁ (650 nm) is the birefringence of the optically anisotropic medium at a wavelength of 650 nm.

In an embodiment, Birefringence dispersion according to the wavelength of the optically anisotropic medium may satisfy Relationships 2A and 2B:

0.70≤Δn₁(450 nm)/Δn₁(550 nm)≤1.00 [Relationship 2A]

1.00≤Δn₁(650 nm)/Δn₁(550 nm)≤1.25 [Relationship 2B]

where, in Relationships 2A and 2B,

Δn₁ (450 nm) is the birefringence of the optically anisotropic medium at a wavelength of 450 nm,

Δn₁ (550 nm) is the birefringence of the optically anisotropic medium at a wavelength of 550 nm, and

Δn₁ (650 nm) is the birefringence of the optically anisotropic medium at a wavelength of 650 nm.

In an embodiment, Birefringence dispersion according to the wavelength of the optically anisotropic medium may satisfy Relationships 2C and 2D:

1.00≤Δn₁(450 nm)/Δn₁(550 nm)≤1.25 [Relationship 2C]

0.70≤Δn₁(650 nm)/Δn₁(550 nm)≤1.00 [Relationship 2D]

where, in Relationships 2C and 2D,

Δn₁ (450 nm) is the birefringence of the optically anisotropic medium at a wavelength of 450 nm,

Δn₁ (550 nm) is the birefringence of the optically anisotropic medium at a wavelength of 550 nm,

Δn₁ (650 nm) is the birefringence of the optically anisotropic medium at a wavelength of 650 nm.

In an embodiment, the diffractive optical element may satisfy Relationship 3:

θ₂×∧₂>θ₁×∧₁ [Relationship 3]

where, in Relationship 3,

θ₂ is a diffraction angle of the diffractive optical element at wavelength λ, where wavelength λ is the wavelength of incident light,

∧₂ is a grating period of the diffractive optical element,

θ₁ is a diffraction angle satisfying Relationship AA, and

∧₁ is a grating period satisfying Relationship AA,

$${θ}_{1} = {sin}^{- 1} ( \frac{λ}{{Λ}_{1}} )$$

where, in Relationship AA,

θ₁ is the diffraction angle at the wavelength λ,

∧₁ is the grating period, and

λ is the wavelength of the incident light.

In an embodiment, the diffractive optical element may satisfy Relationship 4:

θ₂×∧₂n(∧₁×∧₁) [Relationship 4]

where, in Relationship 4,

θ₂ is a diffraction angle of the diffractive optical element at wavelength λ, where the wavelength λ is the wavelength of incident light,

∧₂ is a grating period of the diffractive optical element, and

n is a number of diffractive layers of the diffractive optical element and is an integer from 2 to 10.

In an embodiment, a diffraction angle of a diffractive optical element may be greater than a diffraction angle of each of the plurality of diffractive layers.

In an embodiment, a maximum diffraction angle of the diffractive optical element satisfying a same diffraction efficiency may be greater than the maximum diffraction angle of a single diffractive layer.

In an embodiment, a difference between a maximum diffraction efficiency and a minimum diffraction efficiency at a diffraction angle of greater than about 0 degree and less than or equal to 40 degrees of the diffractive optical element may be less than or equal to about 40 percent (%).

In an embodiment, a diffraction efficiency of the diffractive optical element at a wavelength of 450 nm, a diffraction efficiency of the diffractive optical element at a wavelength of 550 nm, and a diffraction efficiency of the diffractive optical element at a wavelength of 650 nm may be each independently about 50% to about 100%.

In an embodiment, a diffraction angle of the diffractive optical element at a wavelength of 450 nm, a diffraction angle of the diffractive optical element at a wavelength of 550 nm, and a diffraction angle of the diffractive optical element at a wavelength of 650 nm may be each independently about 5 degrees to 50 degrees.

In an embodiment, the plurality of diffractive layers may include two to ten layers.

In another embodiment, a diffractive optical element includes a diffractive layer having one or more grating periods, where the diffractive layer includes a plurality of optical axes that change along an in-plane rotation direction in each grating period and the diffractive optical element satisfies Relationship 3:

θ₂×∧₂>θ₁×∧₁ [Relationship 3]

where, in Relationship 3,

θ₂ is a diffraction angle of the diffractive optical element at wavelength λ, where the wavelength λ is the wavelength of incident light,

∧2 is a grating period of the diffractive optical element,

θ₁ is a diffraction angle satisfying Relationship AA, and

∧₁ is a grating period that satisfying Relationship AA,

$${θ}_{1} = {sin}^{- 1} ( \frac{λ}{{Λ}_{1}} )$$

where, in Relationship AA,

θ₁ is the diffraction angle at the wavelength λ,

∧₁ is the grating period, and

λ is the wavelength of the incident light.

In an embodiment, the diffractive layer may include an optically anisotropic medium, and an optical axis of the diffractive layer may be parallel to a direction of a long axis of the optically anisotropic medium.

In an embodiment, the diffractive optical element may include a first diffractive layer including a plurality of optical axes that change along a first in-plane rotation direction that is one of an in-plane clockwise direction and an in-plane counterclockwise direction in the grating period, and a second diffractive layer including a plurality of optical axes that change along a second in-plane rotation direction that is a remaining one of the in-plane clockwise direction and the in-plane counterclockwise direction in the grating period.

In an embodiment, the diffractive optical element may further include a third diffractive layer including a plurality of optical axes that change along the first in-plane rotation direction in the grating period, where the first diffractive layer, the second diffractive layer, and the third diffractive layer may be sequentially stacked adjacent to each other.

In an embodiment, each of the first diffractive layer and the second diffractive layer may be provided in plural, and the first diffractive layer and the second diffractive layer may be alternately stacked. In an embodiment, the diffractive optical element may satisfy Relationship 4:

θ₂×∧₂=n(θ₁×∧₁) [Relationship 4]

where, in Relationship 4,

θ₂ is a diffraction angle of the diffractive optical element at wavelength λ, where the wavelength λ is the wavelength of incident light,

∧2 is a grating period of the diffractive optical element, and

n is a number of diffractive layers of the diffractive optical element and is an integer from 2 to 10.

In an embodiment, the diffractive optical element may be a lens or a prism.

In an embodiment, the diffractive optical element may be a flat diffractive optical element with a constant thickness and curvature.

In another embodiment, a stacked diffractive optical element includes a plurality of diffractive optical elements.

In an embodiment, the stacked diffractive optical element may include a blue diffractive optical element which exhibits a maximum diffraction efficiency in a wavelength range of greater than or equal to about 400 nm and less than about 500 nm, a green diffractive optical element which exhibits a maximum diffraction efficiency at about 500 nm to about 600 nm, and a red diffractive optical element which exhibits a maximum diffraction efficiency at greater than about 600 nm and less than or equal to about 700 nm.

In an embodiment, the stacked diffractive optical element may further include a wavelength selective filter.

In another embodiment, a device including the diffractive optical element or the stacked diffractive optical element is provided.

While implementing a high diffraction angle without reducing the grating period, improved diffraction efficiency may be exhibited.

### BRIEF DESCRIPTION OF THE DRAWINGS

The above and other exemplary embodiments, advantages and features of this disclosure will become more apparent by describing in further detail exemplary embodiments thereof with reference to the accompanying drawings, in which:

FIG. 1 is a cross-sectional view illustrating an embodiment of a diffractive optical element;

FIG. 2 is a schematic cross-sectional view illustrating an embodiment of a stacked diffractive layer in the diffractive optical element of FIG. 1;

FIG. 3 is a schematic cross-sectional view illustrating an embodiment of the stacked diffractive layer of FIG. 2;

FIG. 4A is a plan view schematically illustrating an embodiment of the stacked diffractive layer of FIG. 2, and FIG. 4B is a graph showing an embodiment of an optical axis of an optically anisotropic medium with a pretilt angle α;

FIG. 5 is a plan view schematically illustrating an embodiment of an arrangement of optical axes in the stacked diffractive layers of FIGS. 3 to 4B;

FIG. 6 is a schematic view illustrating an embodiment of diffraction angles in the diffractive layers of FIGS. 3 to 4B;

FIG. 7 is a cross-sectional view schematically illustrating another embodiment of the stacked diffractive layer of FIG. 2;

FIG. 8 is a plan view schematically illustrating another embodiment of the stacked diffractive layer of FIG. 2;

FIG. 9 is a plan view schematically illustrating an embodiment of an arrangement of optical axes in the stacked diffractive layers of FIGS. 7 and 8;

FIG. 10 is a cross-sectional view schematically illustrating another embodiment of the stacked diffractive layer of FIG. 2;

FIGS. 11 and 12A to 12C are schematic views illustrating an embodiment of stacked diffractive optical elements;

FIGS. 13 to 18 are graphs showing diffraction efficiency according to diffraction angles of diffractive optical elements according to Examples I and II and Reference Example;

FIGS. 19 to 21 are graphs showing diffraction efficiency according to the diffraction angles and the number of diffractive layers of the diffractive optical elements according to Examples Ito VIII and Reference Example; and

FIGS. 22 to 24 are graphs showing diffraction efficiency according to the wavelength and the number of diffractive layers at a predetermined diffraction angle.

### DETAILED DESCRIPTION

Hereinafter, embodiments of the invention will be described in detail so that a person skilled in the art would understand the same. This disclosure may, however, be embodied in many different forms and is not construed as limited to the embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another intended to encompass different orientations of the device in addition to the orientation depicted in the Figures. In an embodiment, when the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” can mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

Hereinafter, a diffractive optical element according to an embodiment is described.

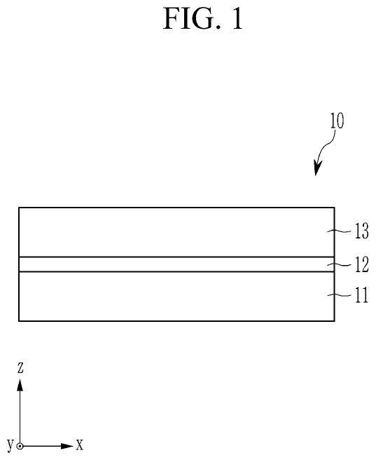

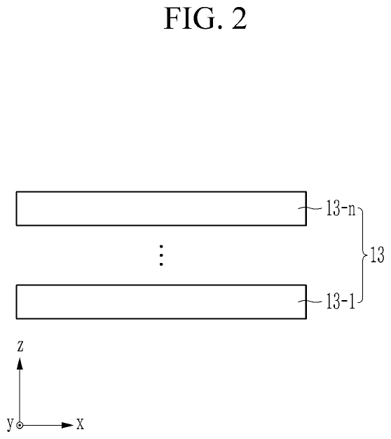

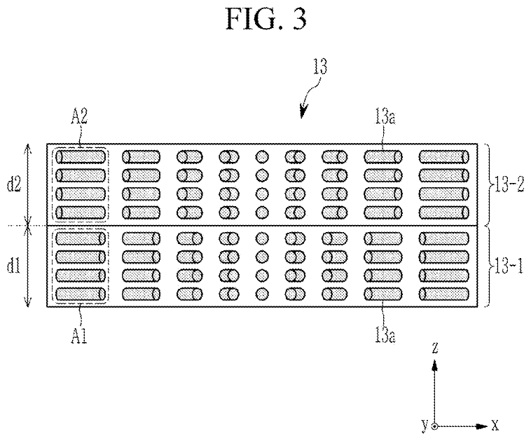

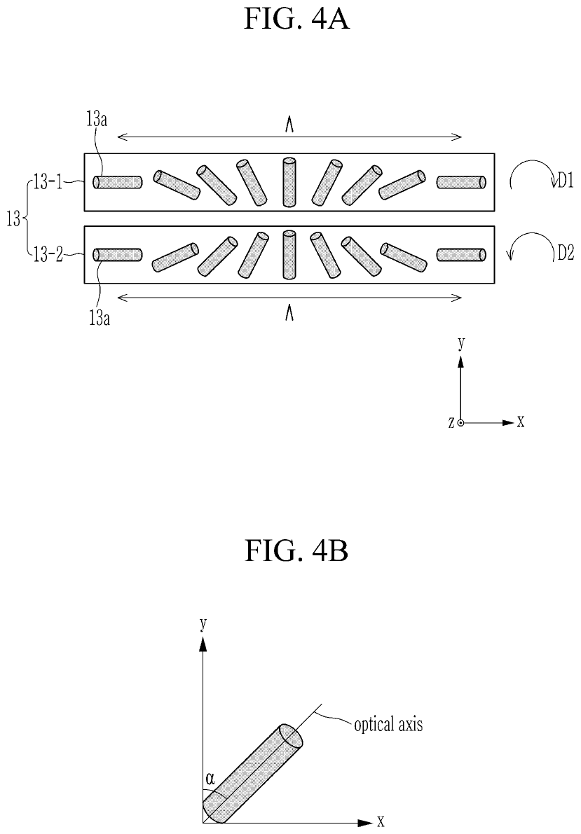

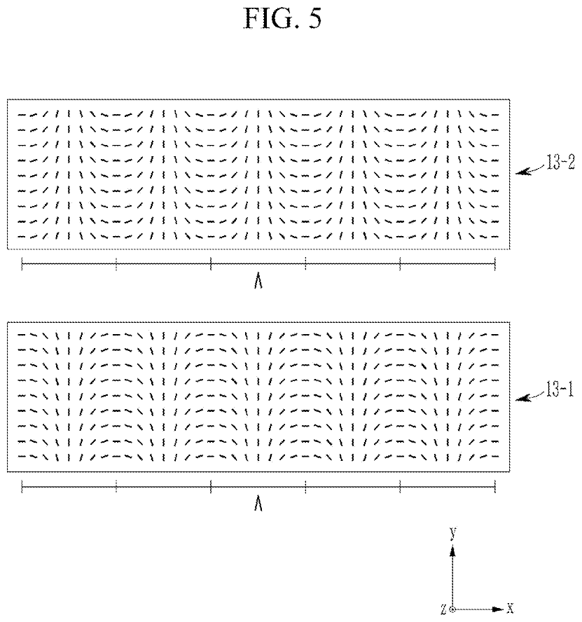

FIG. 1 is a cross-sectional view illustrating an embodiment of a diffractive optical element, FIG. 2 is a schematic cross-sectional view illustrating an embodiment of a stacked diffractive layer in the diffractive optical element of FIG. 1, FIG. 3 is a schematic cross-sectional view illustrating an embodiment of the stacked diffractive layer of FIG. 2, FIG. 4A is a plan view schematically illustrating an embodiment of the stacked diffractive layer of FIG. 2, and FIG. 4B is a graph showing an embodiment of an optical axis of an optically anisotropic medium with a pretilt angle α, FIG. 5 is a plan view schematically illustrating an embodiment of an arrangement of optical axes in the stacked diffractive layers of FIGS. 3 to 4B, and FIG. 6 is a schematic view illustrating an embodiment of diffraction angles in the diffractive layers of FIGS. 3 to 4B.

Referring to FIG. 1, a diffractive optical element 10 in an embodiment includes a substrate 11, an alignment layer 12, and a stacked diffractive layer 13.

In an embodiment, the substrate 11 may include an inorganic material such as glass, an organic material such as polycarbonate, polymethylmethacrylate, polyethyleneterephthalate, polyethylenenaphthalate, polyethyleneterephthalate, polyvinyl alcohol, triacetyl cellulose, polyimide, polyamide, polyamideimide, polyethersulfone, a copolymer thereof, a derivative thereof, or any combinations thereof, or a silicon wafer, but is not limited thereto. In another embodiment, the substrate 11 may be omitted.

In an embodiment, the alignment layer 12 may control orientation of the optically anisotropic medium of the stacked diffractive layer 13 described later, and may include polyvinyl alcohol, polyolefin, polyamic acid, polyimide, or any combinations thereof, for example. The surface of the alignment layer 12 may impart a predetermined orientation capability to the optically anisotropic medium 13a by physical treatment such as rubbing or light treatment such as photoalignment. In another embodiment, the alignment layer 12 may be omitted as needed.

Referring to FIG. 2, the stacked diffractive layer 13 includes a plurality of diffractive layers 13-1, . . . , 13-n stacked along the thickness direction (e.g., z direction), that is, n diffractive layers 13-1, . . . , 13-n. Here, n may be an integer of greater than or equal to 2, and may be an integer of 2 to 20, 2 to 16, 2 to 12, or 2 to 10, but is not limited thereto. Here, the boundary between adjacent diffractive layers 13-1, . . . , 13-n may be divided according to the arrangement of the optically anisotropic medium 13a to be described later, or may be distinguished by an additional layer (not shown) interposed between adjacent diffractive layers 13-1, . . . , 13-n. The additional layer may be, for example, an alignment layer or an adhesive layer, but is not limited thereto.

Each diffractive layer 13-1, . . . , 13-n may be an optical anisotropy layer which changes a propagation direction of light, and accordingly, it may exhibit an extra phase delay in addition to the general phase delay appearing in the isotropy layer. Each of the diffractive layers 13-1, . . . , 13-n may include an optically anisotropic medium 13a capable of exhibiting optically anisotropic characteristics, which will be described later.

Each of the diffractive layers 13-1, . . . , 13-n may serve as a polarization grating, and diffract incident light into circularly polarized light (left-circularly polarized light and/or right-circularly polarized light). In an embodiment, when unpolarized light enters, the diffractive layers 13-1, . . . , 13-n may diffract the unpolarized light into left-circularly polarized light and right-circularly polarized light, for example. In an embodiment, when the right-circularly polarized light enters, the diffractive layers 13-1, . . . , 13-n may diffract the right-circularly polarized light into left-circularly polarized light, for example. In an embodiment, when the left-circularly polarized light enters, the diffractive layers 13-1, . . . , 13-n may diffract the left-circularly polarized light into right-circularly polarized light, for example. The diffractive layers 13-1, . . . , 13-n may be half waveplates.

The diffractive layers 13-1, . . . , 13-n may have one or more grating periods (∧) for polarization gratings, and the grating periods (∧) may be constant or variable. The grating period (∧) may be one rotation length of an optical axis along a length direction (e.g., x direction) of each diffractive layer 13-1, . . . , 13-n. In an embodiment, the grating period (∧) of the diffractive layers 13-1, . . . , 13-n adjacent to each other of the stacked diffractive layer 13 may be substantially equal, and for example, the grating period (∧) of all diffractive layers 13-1, . . . , 13-n of the stacked diffractive layer 13 may be substantially equal.

The diffractive layers 13-1, . . . , 13-n may include a plurality of optical axes that change along an in-plane direction (e.g., xy direction) for each grating period (∧), and, for example, the plurality of optical axes may change along an in-plane rotation direction such as an in-plane clockwise direction or an in-plane counterclockwise direction.

In this case, the stacked diffractive layer 13 may include two adjacent diffractive layers 13-1, . . . , 13-n including a plurality of optical axes that change along in-plane rotation directions opposite to each other in the grating period (∧). That is, one of the adjacent two diffractive layers 13-1, . . . , 13-n may include a plurality of optical axes that change in the in-plane clockwise direction in the grating period (∧), and the other of two adjacent diffractive layers 13-1, . . . 13-n may include a plurality of optical axes that change in an in-plane counterclockwise direction in the grating period (∧). Herein, “adjacent” means that another diffractive layer having optical anisotropy is not interposed between the two diffractive layers 13-1, . . . , 13-n, and for example two adjacent diffractive layers 13-1, . . . , 13-n may be in direct contact, or an additional layer such as an alignment layer or an adhesive layer may be interposed between the two adjacent diffractive layers 13-1, . . . , 13-n.

Referring to FIGS. 3 to 4B, the stacked diffractive layer 13 includes a first diffractive layer 13-1 and a second diffractive layer 13-2 which are stacked adjacent to each other along a thickness direction (e.g., z direction). The first diffractive layer 13-1 and the second diffractive layer 13-2 may be in direct contact, or an additional layer (not shown) such as an alignment layer or an adhesive layer may be interposed between the first diffractive layer 13-1 and the second diffractive layer 13-2. In an embodiment, the stacked diffractive layer 13 may further include an additional diffractive layer (not shown) in addition to the first diffractive layer 13-1 and the second diffractive layer 13-2, and the additional diffractive layer may be disposed under the first diffractive layer 13-1 and/or on the second diffractive layer 13-2. The aforementioned substrate 11 may be disposed under the first diffractive layer 13-1 or may be disposed on the second diffractive layer 13-2. The first diffractive layer 13-1 and the second diffractive layer 13-2 may have predetermined thicknesses d1 and d2, and each thickness d1 and d2 may be the same as each other or different from each other.

Each of the first diffractive layer 13-1 and the second diffractive layer 13-2 includes an optically anisotropic medium 13a for implementing optically anisotropic characteristics. In an embodiment, the optically anisotropic medium 13a may be a liquid crystal or a cured product thereof, and may be a rod-shaped liquid crystal and/or a disk-shaped liquid crystal, for example. In an embodiment, the optically anisotropic medium 13a may be a monomer, an oligomer, and/or a polymer, for example, a liquid crystal having one or more mesogenic moieties and one or more polymerizable functional groups, or a cured product thereof, for example.

In an embodiment, a birefringence of the optically anisotropic medium 13a is a difference between the maximum refractive index and the minimum refractive index of the optically anisotropic medium 13a, and may be less than or equal to about 0.5, less than or equal to about 0.4, or less than or equal to about 0.3, and within the above range, about 0.05 to about 0.5, about 0.05 to about 0.4, about 0.05 to about 0.3, about 0.1 to about 0.5, about 0.1 to about 0.4, about 0.1 to about 0.3, about 0.2 to about 0.5, or about 0.2 to about 0.4, for example.

The optical axes of the first diffractive layer 13-1 and the second diffractive layer 13-2 may be the same as the direction of the long axis (major axis) of the optically anisotropic media 13a, respectively, and accordingly the optical axis depending on the positions of the first diffractive layer 13-1 and the second diffractive layer 13-2 may be adjusted by the arrangement of the optically anisotropic media 13a.

The optically anisotropic media 13a of the first diffractive layer 13-1 and the second diffractive layer 13-2 may be variously arranged along the in-plane direction (e.g., xy direction), and such an arrangement may become a unit pattern in each grating period (∧) and may be repeated throughout the first diffractive layer 13-1 and the second diffractive layer 13-2. FIGS. 3 to 4B illustrate a unit pattern of one grating period (∧) as an example.

The optically anisotropic media 13a of the first diffractive layer 13-1 and the second diffractive layer 13-2 is arranged along an in-plane rotation direction such as a clockwise or counterclockwise direction for each grating period (∧). According to this arrangement of the optically anisotropic media 13a, the first diffractive layer 13-1 and the second diffractive layer 13-2 may each have a plurality of optical axes that continuously change along the in-plane rotation direction, and the optical axis may change continuously along an in-plane rotation direction, such as a clockwise or counterclockwise direction for each grating period (∧). An angle between the long axes of the adjacent optically anisotropic media 13a in the in-plane or an angle between the adjacent optical axes in the in-plane, that is, an orientation angle may be constant or changed uniformly or ununiformly.

The optically anisotropic media 13a of the first diffractive layer 13-1 and the optically anisotropic media 13a of the second diffractive layer 13-2 may be arranged along opposite in-plane diffraction directions. That is, the optically anisotropic media 13a of the first diffractive layer 13-1 may be arranged along the first in-plane rotation direction, which is one of the in-plane clockwise direction D1 and the in-plane counterclockwise direction D2 in the grating period ∧ and the optically anisotropic media 13a of the second diffractive layer 13-2 may be arranged along the second in-plane rotation direction, which is the other of the in-plane clockwise direction D1 and the in-plane counterclockwise direction D2 in the grating period ∧. In an embodiment, the optically anisotropic media 13a of the first diffractive layer 13-1 may be arranged along the in-plane clockwise direction D1 in the grating period ∧, and the optical anisotropic medium 13a of the second diffractive layer 13-2 may be arranged along the in-plane counterclockwise direction D2 in the grating period ∧, for example.

According to the arrangement of the optically anisotropic media 13a of the first diffractive layer 13-1 and the second diffractive layer 13-2, the first diffractive layer 13-1 and the second diffractive layer 13-2 may include a plurality of optical axes that continuously change along the in-plane rotation directions opposite to each other.

Referring to FIG. 5, the first diffractive layer 13-1 may include a plurality of optical axes that continuously change along a first in-plane rotation direction, which is one of an in-plane clockwise direction D1 and an in-plane counterclockwise direction D2 in the grating period ∧, and the second diffractive layer 13-2 may include a plurality of optical axes that continuously change along a second in-plane rotation direction, which is the other of an in-plane clockwise direction D1 and an in-plane counterclockwise direction D2 in the grating period ∧. In an embodiment, the optical axis of the first diffractive layer 13-1 may change continuously along the in-plane clockwise direction D1 in the grating period ∧, and the optical axis of the second diffractive layer 13-2 may change continuously along the in-plane counterclockwise direction D2 in the grating period ∧, for example.

In this way, two adjacent layers of the stacked diffractive layer 13, that is, the first diffractive layer 13-1 and the second diffractive layer 13-2, may include optical axes that continuously change along the in-plane rotation directions opposite to each other, and thereby a high diffraction angle may be implemented without reducing the grating period ∧ of the first diffractive layer 13-1 and the second diffractive layer 13-2.

In general, the diffraction angle may change according to the grating period ∧, and for example, the diffraction angle and the grating period ∧ may be represented by Relationship A.

$$sin {θ}_{m} = ( m \frac{λ}{{Λ}_{1}} ) + sin {θ}_{in}$$

In Relationship A,

m is the diffraction order,

θₘ is the m-order diffraction angle,

θᵢₙ is an incident angle of incident light,

∧₁ is a grating period, and

λ is a wavelength of incident light.

In an embodiment, in Relationship A, when the diffraction order m is 1 and the incident angle θᵢₙ of incident light is 0, the diffraction angle may be represented by Relationship AA, for example.

$${θ}_{1} = {sin}^{- 1} ( \frac{λ}{{Λ}_{1}} )$$

In Relationship AA,

θ₁ is a diffraction angle at the wavelength λ,

∧₁ is a grating period, and

λ is a wavelength of incident light.

That is, according to Relationships A and AA, a high diffraction angle may be implemented by reducing the grating period (∧₁). However, when the grating period ∧ of the diffractive layer in which the optically anisotropic media 13a are arranged is arbitrarily reduced, the misalignment of the optically anisotropic media 13a is liable to occur, and accordingly diffraction efficiency of the diffractive optical element 10 may be reduced and deterioration of physical properties such as haze may occur.

In this embodiment, the diffractive optical element 10 includes a stacked diffractive layer 13 including a plurality of diffractive layers 13-1, . . . , 13-n, and two adjacent layers in the stacked diffractive layers 130, that is, the first diffractive layer 13-1 and the second diffractive layer 13-2 include optical axes that continuously change along the in-plane rotational directions opposite to each other, and thereby the diffraction angle may be increased without reducing the grating period ∧.

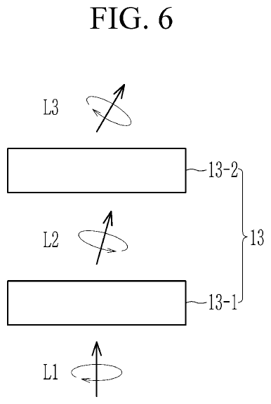

Referring to FIG. 6, when right-circularly polarized (or left-circularly polarized) light L1 enters the diffractive optical element 10, the first diffractive layer 13-1 may diffract right-circularly polarized (or left-circularly polarized) light into left-circularly polarized (or right-circularly polarized) light L2, and the second diffractive layer 13-2 may diffract left-circularly polarized (or right-circularly polarized) light (L2) into right-circularly polarized (or left-circularly polarized) light L3. Accordingly, the diffraction angle of light passing through the stacked diffractive layer 13 may be greater than the diffraction angle of light passing through the first diffractive layer 13-1 or the second diffractive layer 13-2 (single diffractive layer). Accordingly, the maximum diffraction angle of the diffractive optical element 10 satisfying the same diffraction efficiency may be greater than the maximum diffraction angle of the first diffractive layer 13-1 or the second diffractive layer 13-2 (single diffractive layer).

In an embodiment, the diffractive optical element 10 in the illustrated embodiment may satisfy Relationship 3, for example.

θ₂×∧₂>θ₁×∧₁ [Relationship 3]

In Relationship 3,

θ₂ is the diffraction angle of the diffractive optical element at wavelength (λ), where the wavelength λ is the wavelength of incident light (e.g. 450 nanometers (nm), 550 nm, or 650 nm),

∧is a grating period of the diffractive optical element,

θ₁ is a diffraction angle satisfying Relationship AA, and

∧₁ is a grating period satisfying Relationship AA.

In other words, according to Relationship 3, the diffractive optical element 10 in the embodiment may realize a higher diffraction angle with the same grating period (∧₁=∧₂) than a diffractive optical element satisfying Relationship AA.

The optically anisotropic media 13a of the first diffractive layer 13-1 and the second diffractive layer 13-2 may be arranged substantially parallel along the thickness direction (e.g., z direction), and accordingly, the first diffractive layer 13-1 and the second diffractive layer 13-2 may independently have a constant optical axis along the thickness direction (e.g., z direction).

Referring to FIG. 3, the plurality of optically anisotropic media 13a arranged along the thickness direction (e.g., z direction) in the first diffractive layer 13-1 and the second diffractive layer 13-2 may respectively form sections A1 and A2 having each constant optical axis, and the plurality of optically anisotropic media 13a in each of sections A1 and A2 may be non-twisted but arranged substantially parallel along the in-plane direction (e.g., xy direction) of the first diffractive layer 13-1 and the second diffractive layer 13-2. In an embodiment, the plurality of optically anisotropic media 13a in one region A1 of the first diffractive layer 13-1 may be arranged substantially parallel to the lower surface to the upper surface of the first diffractive layer 13-1, and the plurality of optically anisotropic media 13a in one section A2 of the second diffractive layer 13-2 may be arranged substantially parallel to the lower surface to the upper surface of the second diffractive layer 13-2, for example. However, the invention is not limited thereto, but either one of the first diffractive layer 13-1 and the second diffractive layer 13-2 may include a plurality of optically anisotropic media 13a twisted along the in-plane direction (e.g., xy direction).

Angles between the optically anisotropic medium 13a in one section A1 of the first diffractive layer 13-1 and the optically anisotropic medium 13a in one section A2 of the second diffractive layer 13-2 in each grating period ∧ may be different along the in-plane direction (e.g., xy direction), for example, angles between the optically anisotropic medium 13a in one section A1 of the first diffractive layer 13-1 and the optically anisotropic medium 13a in one section A2 of the second diffractive layer 13-2 in each grating period ∧ may continuously change from about 0 degree and about 180 degrees. Accordingly, in each grating period ∧, an angle between the optical axis of the first diffractive layer 13-1 and the optical axis of the second diffractive layer 13-2 overlapped along thickness direction (e.g., z direction) of the first diffractive layer 13-1 and the second diffractive layer 13-2 may continuously change from about 0 degree and about 180 degrees.

The first diffractive layer 13-1 and the second diffractive layer 13-2 may have substantially the same grating period ∧, and the same grating period ∧ may be repeated throughout the first diffractive layer 13-1 and the second diffractive layer 13-2.

In an embodiment, the grating period (∧) of the first diffractive layer 13-1 and the second diffractive layer 13-2 may be greater than or equal to about 1.7 micrometers (μm), within the range, greater than or equal to about 1.9 μm, greater than or equal to about 2.0 μm, greater than or equal to about 2.2 μm, greater than or equal to about 2.5 μm, greater than or equal to about 3.0 μm, greater than or equal to about 3.5 μm, greater than or equal to about 4.0 μm, greater than or equal to about 4.2 μm, or greater than or equal to about 4.5 μm and within the range, about 1.7 μm to 10 μm, about 1.9 μm to 10 μm, about 2.0 μm to 10 μm, about 2.2 μm to about 10 μm, about 2.5 μm to about 10 μm, about 3.0 μm to about 10 μm, about 3.5 μm to about 10 μm, about 4.0 μm to about 10 μm, about 4.2 μm to about 10 μm, or about 4.5 μm to about 10 μm, for example.

Birefringence of the optically anisotropic medium 13a may be constant or variable depending on a wavelength, and when the birefringence is variable depending on the wavelength, the birefringence may decrease or increase, as the wavelength increases. In an embodiment, birefringence dispersion of the optically anisotropic medium 13a may be compared by magnitude of the birefringence at a plurality of wavelengths in the visible wavelength region, for example, magnitudes of the birefringences at a wavelength of 450 nm, a wavelength of 550 nm, and a wavelength of 650 nm may be compared.

In an embodiment, birefringence dispersion of the optically anisotropic medium 13a at a wavelength of 450 nm, a wavelength of 550 nm, and a wavelength of 650 nm may satisfy one of Relationships 1A to 1E, for example.

Δn₁(450 nm)<Δn₁(550 nm)≤Δn₁(650 nm) [Relationship 1A]

Δn₁(450 nm)≤Δn₁(550 nm)<Δn₁(650 nm) [Relationship 1B]

Δn₁(450 nm)=Δn₁(550 nm)=Δn₁(650 nm) [Relationship 1C]

Δn₁(450 nm)≥Δn₁(550 nm)>Δn₁(650 nm) [Relationship 1D]

Δn₁(450 nm)>Δn₁(550 nm)≥Δn₁(650 nm) [Relationship 1E]

In Relationships 1A to 1E,

Δn₁ (450 nm) is the birefringence of the optically anisotropic medium of a wavelength of 450 nm,

Δn₁ (550 nm) is the birefringence of the optically anisotropic medium of a wavelength of 550 nm, and

Δn₁ (650 nm) is the birefringence of the optically anisotropic medium of a wavelength of 650 nm.

In an embodiment, a birefringence dispersion of the optically anisotropic medium 13a in the short wavelength region may be expressed as a birefringence ratio to those at a wavelength of 450 nm and a wavelength of 550 nm, and a birefringence dispersion of the optically anisotropic medium 13a in the long wavelength region may be expressed as a birefringence ratio to those at a wavelength of 550 nm and a wavelength of 650 nm, for example.

In an embodiment, the optically anisotropic medium 13a may have the same or greater birefringence dispersion as the wavelength goes toward a longer wavelength as in Relationship 1A, 1 B, or 1C, where the birefringence of the optically anisotropic medium 13a may satisfy, for example, Relationships 2A and 2B.

0.70≤Δn₁(450 nm)/Δn₁(550 nm)≤1.00 [Relationship 2A]

1.00≤Δn₁(650 nm)/Δn₁(550 nm)≤1.25 [Relationship 2B]

Within the above range, the optically anisotropic medium 13a may satisfy Relationships 2A-1 and 2B-1.

0.72≤Δn₁(450 nm)/Δn₁(550 nm)≤0.95 [Relationship 2A-1]

1.05≤Δn₁(650 nm)/Δn₁(550 nm)≤1.25 [Relationship 2B-1]

Within the above range, the optically anisotropic medium 13a may satisfy the following relationships 2A-2 and 2B-2.

0.75≤Δn₁(450 nm)/Δn₁(550 nm)≤0.95 [Relationship 2A-2]

1.07≤Δn₁(650 nm)/Δn₁(550 nm)'1.20 [Relationship 2B-2]

Within the above range, the optically anisotropic medium 13a may satisfy Relationships 2A-3 and 2B-3.

0.80≤Δn₁(450 nm)/Δn₁(550 nm)≤0.92 [Relationship 2A-3]

1.08≤Δn₁(650 nm)/Δn₁(550 nm)≤1.19 [Relationship 2B-3]

In an embodiment, the optically anisotropic medium 13a may have the same or smaller birefringence dispersion goes toward a longer wavelength as in Relationship 1C, 1D, or 1E, where the birefringence of the optically anisotropic medium 13a may satisfy Relationships 2C and 2D, for example.

1.00≤Δn₁(450 nm)/Δn₁(550 nm)≤1.25 [Relationship 2C]

0.70≤Δn₁(650 nm)/Δn₁(550 nm)≤1.00 [Relationship 2D]

Within the above range, the optically anisotropic medium 13a may satisfy Relationships 2C-1 and 2D-1.

1.05≤Δn₁(450 nm)/Δn₁(550 nm)≤1.25 [Relationship 2C-1]

0.72≤Δn₁(650 nm)/Δn₁(550 nm)≤0.95 [Relationship 2D-1]

Within the above range, the optically anisotropic medium 13a may satisfy Relationships 2C-2 and 2D-2.

1.07≤Δn₁(450 nm)/Δn₁(550 nm)≤1.20 [Relationship 2D-1]

0.75≤Δn₁(650 nm)/Δn₁(550 nm)≤0.95 [Relationship 2D-2]

Within the above range, the optically anisotropic medium 13a may satisfy Relationships 2C-3 and 2C-3.

1.08≤Δn₁(450 nm)/Δn₁(550 nm)≤1.19 [Relationship 2C-3]

0.80≤Δn₁(650 nm)/Δn₁(550 nm)≤0.92 [Relationship 2C-3]

The diffractive optical element 10 may improve diffraction efficiency in the visible light region by including the aforementioned stacked diffractive layer 13.

In an embodiment, the diffraction efficiency of the diffractive optical element 10 at one of a wavelength of 450 nm, a wavelength of 550 nm, and a wavelength of 650 nm may be greater than or equal to about 60%, and within the above range, greater than or equal to about 65%, greater than or equal to about 70%, greater than or equal to about 75%, greater than or equal to about 80%, greater than or equal to about 85%, greater than or equal to about 90%, or greater than or equal to about 95%, for example.

In an embodiment, each diffraction efficiency of the diffractive optical element 10 at a wavelength of 450 nm, a wavelength of 550 nm, and a wavelength of 650 nm may be greater than or equal to about 50%, and within the above range, greater than or equal to about 55%, greater than or equal to about 60%, greater than or equal to about 65%, or greater than or equal to about 70%, for example.

In an embodiment, when the diffraction efficiency of the diffractive optical element 10 at a wavelength of 450 nm, a wavelength of 550 nm, and a wavelength of 650 nm is first diffraction efficiency, second diffraction efficiency, and third diffraction efficiency, respectively, a difference between the maximum diffraction efficiency and the minimum diffraction efficiency among the first diffraction efficiency, the second diffraction efficiency, and the third diffraction efficiency may be less than or equal to about 40%, and within the above range, less than or equal to about 35%, less than or equal to about 30%, less than or equal to about 25%, less than or equal to about 20%, less than or equal to about 18%, less than or equal to about 16%, less than or equal to about 15%, less than or equal to about 12%, less than or equal to about 10%, less than or equal to about 8%, less than or equal to about 5%, less than or equal to about 3%, less than or equal to about 2%, or less than or equal to about 1%, for example. In an embodiment, the difference between the maximum diffraction efficiency and the minimum diffraction efficiency among the first diffraction efficiency, the second diffraction efficiency, and the third diffraction efficiency may be about 0% to about 40%, about 0% to about 35%, about 0% to about 30%, about 0% to about 25%, about 0% to about 20%, about 0% to about 18%, about 0% to about 16%, about 0% to about 15%, about 0% to about 12%, about 0% to about 10%, about 0% to about 8%, about 0% to about 5%, about 0% to about 3%, about 0% to about 2%, about 0% to about 1%, about 0.01% to about 40%, about 0.05% to about 40%, about 0.1% to about 40%, about 0.2% to about 40%, or about 0.5% to about 40%, for example.

In an embodiment, the diffractive optical element 10 may satisfy predetermined diffraction efficiency even at a high diffraction angle, for example. In an embodiment, a difference between the maximum diffraction efficiency and the minimum diffraction efficiency at a diffraction angle of greater than about 0 degree and less than or equal to about 40 degrees of the diffractive optical element 10 may be less than or equal to about 40%, and within the above range, less than or equal to about 35%, less than or equal to about 30%, less than or equal to about 25%, less than or equal to about 20%, less than or equal to about 18%, less than or equal to about 16%, less than or equal to about 15%, less than or equal to about 12%, less than or equal to about 10%, less than or equal to about 8%, less than or equal to about 5%, less than or equal to about 3%, less than or equal to about 2%, or less than or equal to about 1%, for example. In an embodiment, the difference between the maximum diffraction efficiency and the minimum diffraction efficiency at a diffraction angle of greater than about 0 degree and less than or equal to about 40 degrees of the diffractive optical element 10 may be about 0% to about 40%, about 0% to about 35%, about 0% to about 30%, about 0% to about 25%, about 0% to about 20%, about 0% to about 18%, about 0% to about 16%, about 0% to about 15%, about 0% to about 12%, about 0% to about 10%, about 0% to about 8%, about 0% to about 5%, about 0% to about 3%, about 0% to about 2%, about 0% to about 1%, about 0.01% to about 40%, about 0.05% to about 40%, about 0.1% to about 40%, about 0.2% to about 40%, or about 0.5% to about 40%, for example.

In an embodiment, the diffractive optical element 10 includes the optically anisotropic medium 13a satisfying either one of Relationships 1A to 1C and/or 2A and 2B and thus may improve a bandwidth in the visible light region, for example. The bandwidth may be a width of a wavelength region satisfying predetermined diffraction efficiency, for example, a width of predetermined diffraction efficiency in the visible wavelength region.

In an embodiment, the bandwidth of the diffractive optical element 10 satisfying diffraction efficiency of greater than or equal to about 50% in a wavelength region of about 400 nm to about 700 nm may be greater than or equal to about 180 nm, for example. Within the above range, the above bandwidth may be greater than or equal to about 190 nm, greater than or equal to about 200 nm, greater than or equal to about 210 nm, or greater than or equal to about 220 nm, and within the above range, about 180 nm to about 300 nm, about 190 nm to about 300 nm, about 200 nm to about 300 nm, about 210 nm to about 300 nm, or about 220 nm to about 300 nm.

In an embodiment, the bandwidth of the diffractive optical element 10 satisfying diffraction efficiency of greater than or equal to about 60% in a wavelength region of about 400 nm to about 700 nm may be greater than or equal to about 180 nm, for example. Within the above range, the above bandwidth may be greater than or equal to about 190 nm, greater than or equal to about 200 nm, greater than or equal to about 210 nm, or greater than or equal to about 220 nm, and within the above range about 180 nm to about 300 nm, about 190 nm to about 300 nm, about 200 nm to about 300 nm, about 210 nm to about 300 nm, or about 220 nm to about 300 nm.

In an embodiment, the bandwidth of the diffractive optical element 10 satisfying diffraction efficiency of greater than or equal to about 70% in a wavelength region of about 400 nm to about 700 nm may be greater than or equal to about 180 nm, for example. Within the above range, the above bandwidth may be greater than or equal to about 190 nm, greater than or equal to about 200 nm, greater than or equal to about 210 nm, or greater than or equal to about 220 nm, and within the above range about 180 nm to about 300 nm, about 190 nm to about 300 nm, about 200 nm to about 300 nm, about 210 nm to about 300 nm, or about 220 nm to about 300 nm.

In an embodiment, the bandwidth of the diffractive optical element 10 satisfying diffraction efficiency of greater than or equal to about 80% in a wavelength region of about 400 nm to about 700 nm may be greater than or equal to about 180 nm, for example. Within the above range, the above bandwidth may be greater than or equal to about 190 nm, greater than or equal to about 200 nm, greater than or equal to about 210 nm, or greater than or equal to about 220 nm, and within the above range about 180 nm to about 300 nm, about 190 nm to about 300 nm, about 200 nm to about 300 nm, about 210 nm to about 300 nm, or about 220 nm to about 300 nm.

In an embodiment, the bandwidth of the diffractive optical element 10 satisfying diffraction efficiency of greater than or equal to about 90% in a wavelength region of about 400 nm to about 700 nm may be greater than or equal to about 180 nm, for example. Within the above range, the above bandwidth may be greater than or equal to about 190 nm, greater than or equal to about 200 nm, greater than or equal to about 210 nm, or greater than or equal to about 220 nm, within the above range, about 180 nm to about 300 nm, about 190 nm to about 300 nm, about 200 nm to about 300 nm, about 210 nm to about 300 nm, or about 220 nm to about 300 nm.

The diffractive optical element 10 in the embodiment may realize a high diffraction angle without reducing a grating period and simultaneously, has relatively high diffraction efficiency at the high diffraction angle and thus may realize a high performance diffractive optical element.

Hereinafter, another embodiment of the diffractive optical element is described with reference to the drawings.

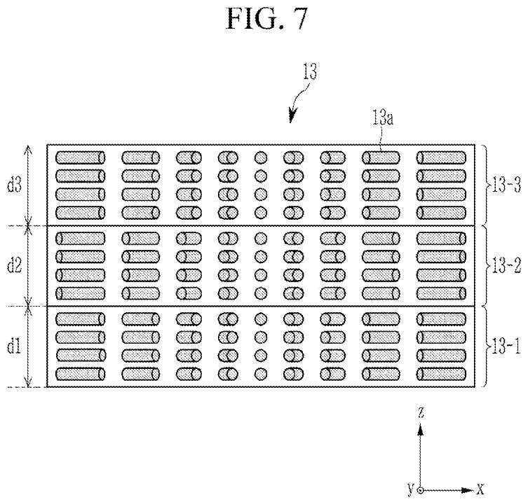

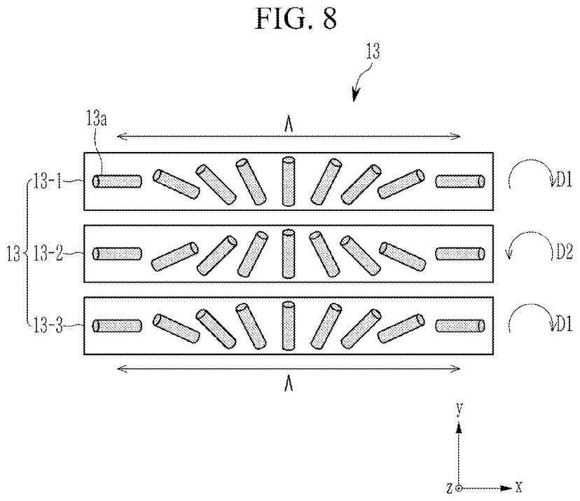

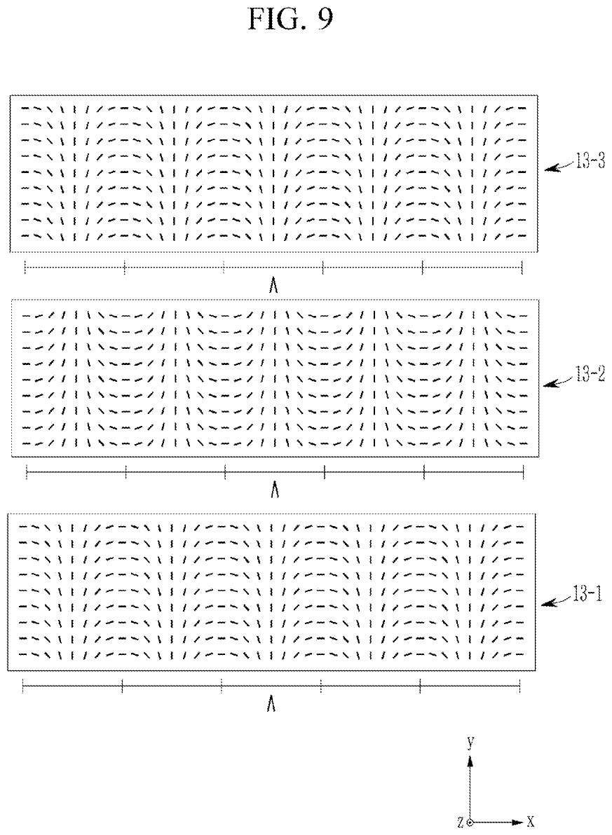

FIG. 7 is a cross-sectional view schematically illustrating another embodiment of the stacked diffractive layer of FIG. 2, FIG. 8 is a plan view schematically illustrating another embodiment of the stacked diffractive layer of FIG. 2, and FIG. 9 is a plan view schematically illustrating an embodiment of an arrangement of optical axes in the stacked diffractive layers of FIGS. 7 and 8.

Referring to FIGS. 7 and 8, the stacked diffractive layer 13 may include a first diffractive layer 13-1, a second diffractive layer 13-2, and a third diffractive layer 13-3 which are stacked adjacent to each other along the thickness direction (e.g. z-direction). The first diffractive layer 13-1, the second diffractive layer 13-2, and the third diffractive layer 13-3 may each be in direct contact, or an additional layer (not shown) such as alignment layer or an adhesive layer may be disposed between the first diffractive layer 13-1 and the second diffractive layer 13-2 and/or between the second diffractive layer 13-2 and the third diffractive layer 13-3. The aforementioned substrate 11 may be disposed under the first diffractive layer 13-1 or on the third diffractive layer 13-3.

The first diffractive layer 13-1 and the second diffractive layer 13-2 are the same as described above, and therefore a redundant description thereof may be omitted.

The third diffractive layer 13-3 may include the optically anisotropic media 13a variously arranged in an in-plane direction (e.g., xy direction), and the optically anisotropic media 13a of the third diffractive layer 13-3 may be arranged along a first in-plane rotation direction, which is one of an in-plane clockwise direction D1 and an in-plane counterclockwise direction D2 in the grating period ∧, like the first diffractive layer 13-1. In an embodiment, the optically anisotropic media 13a of the first diffractive layer 13-1 and the third diffractive layer 13-3 may be arranged along the in-plane clockwise direction D1 in the grating period ∧, and the optical anisotropic medium 13a of the second diffractive layer 13-2 may be arranged along the in-plane counterclockwise direction D2 in the grating period ∧, for example.

According to the arrangements of the optically anisotropic media 13a of the first diffractive layer 13-1, the second diffractive layer 13-2, and the third diffractive layer 13-3, the first diffractive layer 13-1, the second diffractive layer 13-2, and the third diffractive layer 13-3 may include a plurality of optical axes that continuously change along an in-plane rotation direction opposite to that of the adjacent diffractive layers. In an embodiment, the third diffractive layer 13-3 may have a thickness d3 along the thickness direction (e.g. z-direction), and the thickness d3 may be the same as at least one of the thickness d1 of the first diffractive layer 13-1 and the thickness d2 of the second diffractive layer 13-2, or different from at least one of the thickness d1 of the first diffractive layer 13-1 and d2 of the second diffractive layer 13-2.

Referring to FIG. 9, the first diffractive layer 13-1 may include a plurality of optical axes that continuously change along a first in-plane rotation direction, which is one of an in-plane clockwise direction D1 and an in-plane counterclockwise direction D2 in the grating period ∧, the second diffractive layer 13-2 may include a plurality of optical axes that continuously change along a second in-plane rotation direction, which is the other of an in-plane clockwise direction D1 and an in-plane counterclockwise direction D2 in the grating period ∧, and third diffractive layer 13-3 may include a plurality of optical axes that continuously change along a first in-plane rotation direction, which is one of an in-plane clockwise direction D1 and an in-plane counterclockwise direction D2 in the grating period ∧. In an embodiment, the optical axes of the first diffractive layer 13-1 and the third diffractive layer 13-3 may change continuously along the in-plane clockwise direction D1 in the grating period ∧, and the optical axis of the second diffractive layer 13-2 may change continuously along the in-plane counterclockwise direction D2 in the grating period ∧, for example.

Hereinafter, another embodiment of the diffractive optical element is described with reference to the drawings.

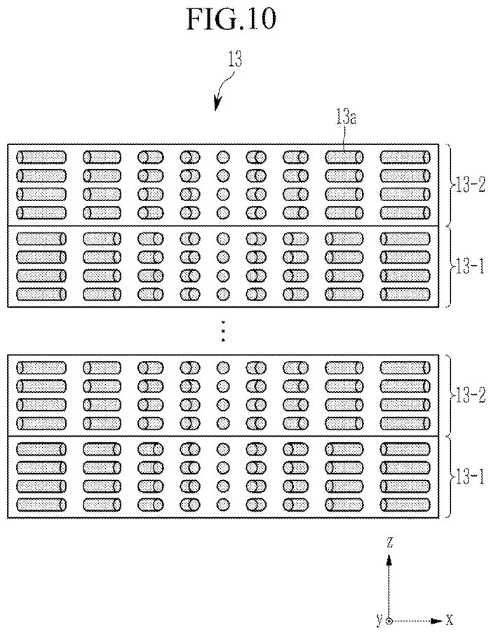

FIG. 10 is a cross-sectional view schematically illustrating another embodiment of the stacked diffractive layer of FIG. 2.

Referring to FIG. 10, the stacked diffractive layer 13 includes a plurality of first diffractive layers 13-1 and a plurality of second diffractive layers 13-2 that are stacked adjacent to each other along a thickness direction (e.g., z direction), and the first diffractive layer 13-1 and the second diffractive layer 13-2 may be alternately stacked. A pair of the first diffractive layer 13-1 and the second diffractive layer 13-2 may be stacked. Descriptions of each of the first diffractive layer 13-1 and the second diffractive layer 13-2 are the same as described above, and therefore a redundant description thereof may be omitted.

As described above, since the first diffractive layer 13-1 may include a plurality of optical axes that continuously change along a first in-plane rotation direction, which is one of an in-plane clockwise direction D1 (refer to FIG. 8) and an in-plane counterclockwise direction D2 (refer to FIG. 8) in the grating period ∧ and the second diffractive layer 13-2 may include a plurality of optical axes that change along the second in-plane rotation direction, which is the other of the in-plane clockwise direction D1 and in-plane counterclockwise direction D2 in the grating period ∧, the stacked diffractive layer 13 may include a plurality of optical axes that continuously change along in-plane diffraction directions opposite to each other in two adjacent layers. Accordingly, a higher diffraction angle may be implemented without reducing the grating period ∧ of the diffractive optical element 10 as described above.

In an embodiment, the diffractive optical element 10 may satisfy Relationship 4, for example.

θ₂×∧=n(θ₁×∧₁) [Relationship 4]

In Relationship 4,

θ₂ is a diffraction angle of the diffractive optical element at wavelength λ, where the wavelength λ is the wavelength of incident light (e.g. 450 nm, 550 nm, or 650 nm),

∧₂ is a grating period of the diffractive optical element,

θ₁ is a diffraction angle satisfying Relationship AA, and

∧₁ is a grating period satisfying the relation AA,

n is the number of diffractive layers of the diffractive optical element.

In an embodiment, a total number of the first diffractive layer 13-1 and the second diffractive layer 13-2 may be, for example, 2 to 20, and within the above range, 2 to 16, 2 to 12, or 2 to 10, but is not limited thereto.

The aforementioned diffractive optical element 10 may be, for example, a lens or a prism. The diffractive optical element 10 may be a flat diffractive optical element such as a flat lens or a flat prism having a constant thickness and curvature, and may perform functions of both concave lens and convex lens of various focal distances without changing shapes and curvatures, by adjusting the aforementioned grating period and diffraction angle.

The aforementioned diffractive optical element may be used as a component of a stacked diffractive optical element including a plurality of diffractive optical elements which selectively diffract light of different wavelengths.

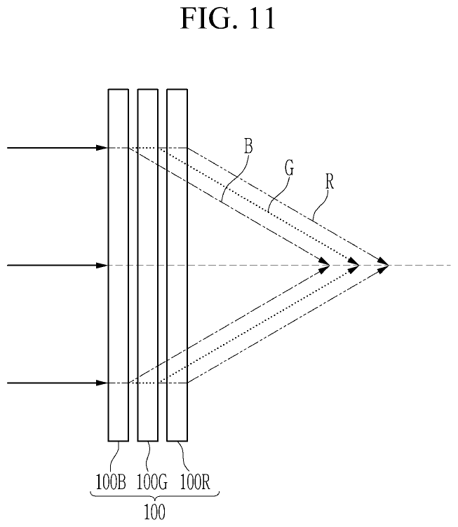

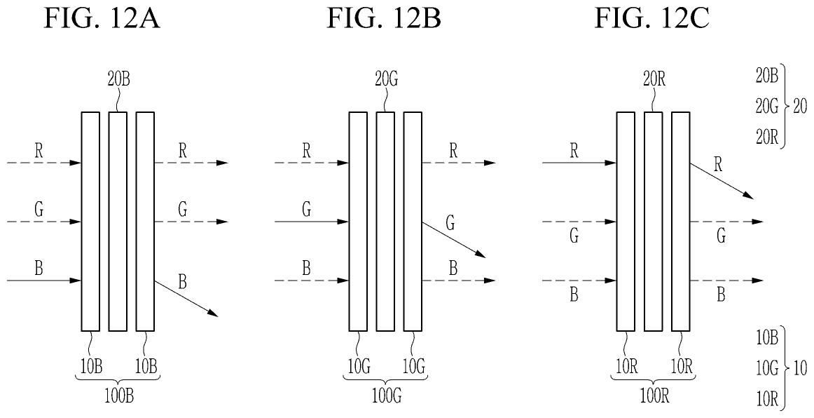

FIGS. 11 and 12A to 12C are schematic views illustrating an embodiment of stacked diffractive optical elements.

In an embodiment, the stacked diffractive optical element 100 may include a blue diffractive optical element 100B that exhibits maximum diffraction efficiency in a wavelength range of greater than or equal to about 400 nm and less than about 500 nm, a green diffractive optical element 100G that exhibits maximum diffraction efficiency in a wavelength range of about 500 nm to about 600 nm, and a red diffractive optical element 100R that exhibits maximum diffraction efficiency in a wavelength range of greater than about 600 nm and less than or equal to about 700 nm, for example. In an embodiment, at least one of the blue diffractive optical element 100B, the green diffractive optical element 100G, and the red diffractive optical element 100R may include the aforementioned diffractive optical element 10, for example. In an embodiment, each of the blue diffractive optical element 100B, the green diffractive optical element 100G, and the red diffractive optical element 100R may include the aforementioned diffractive optical element 10, for example.

In an embodiment, the stacked diffractive optical element 100 may have the same diffraction angles at a wavelength of 450 nm, a wavelength of 550 nm, and a wavelength of 650 nm which may be within about 1 degree to about 50 degrees, and within the above range, about 2 degrees to about 50 degrees, about 5 degrees to about 50 degrees, about 10 degrees to about 50 degrees, about 15 degrees to about 50 degrees, about 20 degrees to about 50 degrees, or about 20 degrees to about 40 degrees, for example.

In an embodiment, grating periods at a wavelength of 450 nm, a wavelength of 550 nm, and a wavelength of 650 nm of the stacked diffractive optical element 100 may be different from each other, for example. In an embodiment, the grating period at a wavelength of 450 nm may be smaller than the grating period at 550 nm wavelength and the grating period at a wavelength of 550 nm may be smaller than the grating period at a wavelength of 650 nm, for example.

In an embodiment, the blue diffractive optical element 100B, the green diffractive optical element 100G, and the red diffractive optical element 100R each further include a pair of the aforementioned diffractive optical elements 10 and a wavelength selective filter 20 interposed therebetween, for example.

Referring to FIGS. 12A to 12C, the blue diffractive optical element 100B may include a pair of diffractive optical elements 10B and a blue wavelength selective filter 20B interposed therebetween, the green diffractive optical element 100G may include a pair of diffractive optical elements 10G and a green wavelength selective filter 20G interposed therebetween, and the red diffractive optical element 100R may include a pair of diffractive optical elements 10R and a red wavelength selective filter 20R interposed therebetween. The blue wavelength selective filter 20B included in the blue diffractive optical element 100B may exhibit, for example, half waveplate characteristics in a blue wavelength region such as, for example, a wavelength of about 450 nm, the green wavelength selective filter 20G included in the green diffractive optical element 10G may exhibit half waveplate characteristics in a green wavelength region such as, for example, a wavelength of about 550 nm, and the red wavelength selective filter 20R included in the red diffractive optical element 10R may exhibit, for example, half waveplate characteristics in a red wavelength region such as, for example, a wavelength of about 650 nm.

The stacked diffractive optical element 100 may combine a plurality of diffractive optical elements suitable for each wavelength region to realize further improved diffraction angle, diffraction efficiency, and bandwidth.

The aforementioned diffractive optical element and stacked diffractive optical element may be included in various devices requiring diffraction characteristics, such as optical devices, augmented reality (“AR”) devices, virtual reality (“VR”) devices, a holographic device, or a three-dimensional (“3D”) printer.

Hereinafter, the embodiments are illustrated in more detail with reference to examples. However, these examples are exemplary, and the scope is not limited thereto.

### Design of Diffractive Optical Element I

### (1) Design of Optically Anisotropic Medium

Optically anisotropic media (liquid crystals) having a birefringence distribution shown in Table 1 are set.

TABLE 1

| | | | | Δn₁ | Δn₁ |
|---|---|---|---|---|---|
| Optically | | | | (450 nm)/ | (650 nm)/ |
| anisotropic | Δn₁ | Δn₁ | Δn₁ | Δn₁ | Δn₁ |
| medium | (450 nm) | (550 nm) | (650 nm) | (550 nm) | (550 nm) |
| Liquid | 0.164 | 0.200 | 0.236 | 0.818 | 1.182 |
| crystal A | | | | | |
| Liquid | 0.182 | 0.200 | 0.218 | 0.909 | 1.091 |
| crystal B | | | | | |
| Liquid | 0.200 | 0.200 | 0.200 | 1.000 | 1.000 |
| crystal C | | | | | |
| Liquid | 0.218 | 0.200 | 0.190 | 1.088 | 0.949 |
| crystal D | | | | | |

### (2) Other Design

### 1) Reference Example (Diffractive Optical Element Satisfying Relationship AA)

Structure: diffractive optical element including a single diffractive layer
Optically anisotropic medium: one of liquid crystals A to D in Table 1
Average refractive index of optically anisotropic medium: 1.58
Birefringence (Δn): 0.2
Diffraction angle (θ): 15 degrees to 40 degrees
Grating period (∧₁): Calculation of the grating period satisfying the diffraction angle from Relationship AA (0.86 μm to 2.13 μm)
Optical axis direction: changes continuously in the in-plane clockwise direction for each grating period
Thickness: the thickness is set to be a λ/2 waveplate at a wavelength of 550 nm

### 2) Example I (2-Layered Diffractive Layer)

Structure: diffractive optical elements shown in FIGS. 1, and 3 to 5
Optically anisotropic medium: one of liquid crystals A to D in Table 1
Average refractive index of optically anisotropic medium: 1.58
Birefringence (Δn): 0.2
Diffraction angle (θ): 15 degrees to 40 degrees
Grating period (∧₀): grating period of Reference Example×2 (the grating periods of the first and second diffractive layers are the same)
Optical axis direction:

i) Optical axis direction of the first diffractive layer: It changes continuously along the in-plane clockwise direction for each grating period.

ii) Optical axis direction of the second diffractive layer: It changes continuously along the in-plane counterclockwise direction for each grating period.
Thickness: The thicknesses are set to be a λ/2 waveplate at a wavelength of 550 nm (Thicknesses of the first and second diffractive layers are the same)

### 3) Example II (3-Layered Diffractive Layer)

Structure: diffractive optical elements shown in FIGS. 1, and 7 to 9
Optically anisotropic medium: one of liquid crystals A to D in Table 1
Average refractive index of optically anisotropic medium: 1.58
Birefringence (Δn): 0.2
Diffraction angle (θ): 15 degrees to 40 degrees
Grating period (∧): grating period of Reference Example×3 (grating periods of the first, second and third diffractive layers are the same)
Optical axis direction:

i) Optical axis direction of the first diffractive layer: It changes continuously along the in-plane clockwise direction for each grating period.

ii) Optical axis direction of the second diffractive layer: It changes continuously along the in-plane counterclockwise direction for each grating period.

iii) Optical axis direction of the third diffractive layer: It changes continuously along the in-plane clockwise direction for each grating period.
Thickness: The thicknesses are set to be a λ/2 waveplate at a wavelength of 550 nm (Thicknesses of the first, second, and third diffractive layers are the same)

### 4) Example III (4-Layered Diffractive Layer)

In FIG. 2, n=4, and a structure in which the first diffractive layer and the second diffractive layer are alternately stacked
Optically anisotropic medium: Liquid crystal A of Table 1
Other designs are the same as in Example I or II.

### 5) Example IV (5-Layered Diffractive Layer)

In FIG. 2, n=5, and a structure in which the first and second diffractive layers are alternately stacked
Optically anisotropic medium: Liquid crystal A of Table 1
Other designs are the same as in Example I or II.

### 6) Example V (6-layered Diffractive Layer)

In FIG. 2, n=6, and a structure in which the first and second diffractive layers are alternately stacked
Optically anisotropic medium: Liquid crystal A of Table 1
Other designs are the same as in Example I or II.

### 7) Example VI (7-Layered Diffractive Layer)

In FIG. 2, n=7, and a structure in which the first and second diffractive layers are alternately stacked
Optically anisotropic medium: Liquid crystal A of Table 1
Other designs are the same as in Example I or II.

### 8) Example VII (8-Layered Diffractive Layer)

In FIG. 2, n=8, and a structure in which the first and second diffractive layers are alternately stacked
Optically anisotropic medium: Liquid crystal A of Table 1
Other designs are the same as in Example I or II.

### 9) Example VIII (9-Layered Diffractive Layer)

In FIG. 2, n=9, and a structure in which the first and second diffractive layers are alternately stacked
Optically anisotropic medium: Liquid crystal A of Table 1
Other designs are the same as in Example I or II.

### Simulation I

A finite-difference time domain (“FDTD”) software (Lumerical Inc.) is used to perform an optical simulation of a diffractive optical element designed under the above-mentioned conditions.

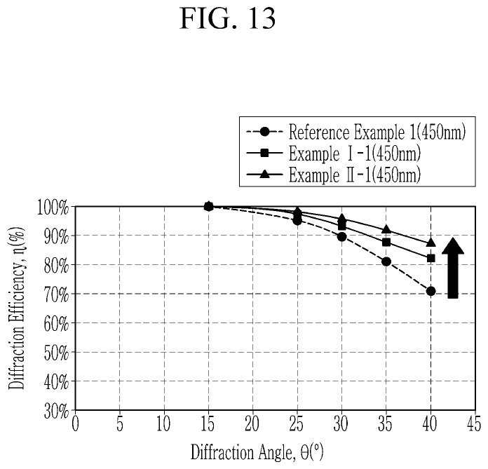

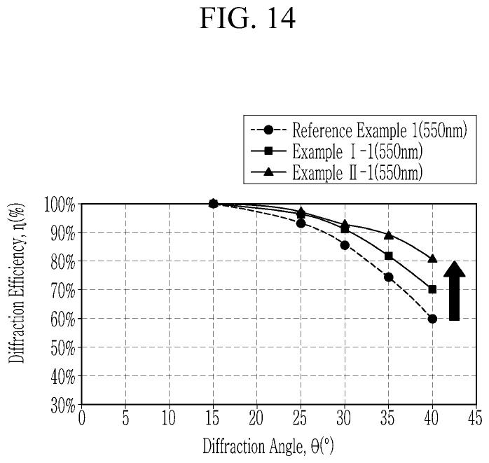

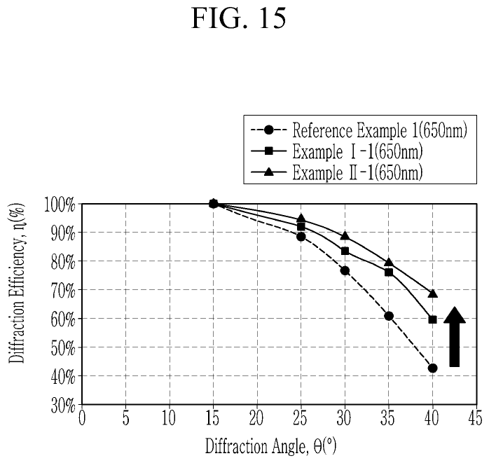

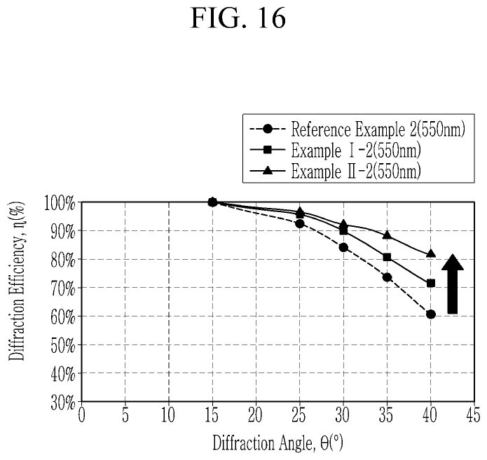

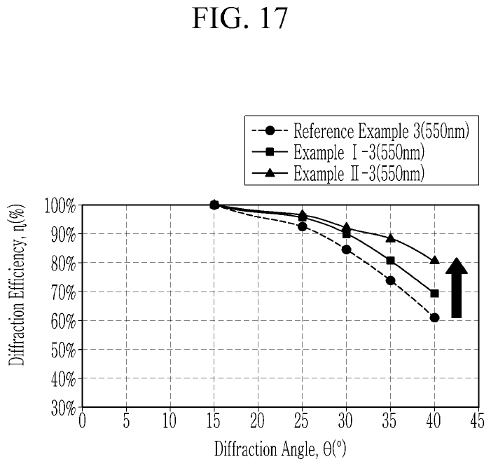

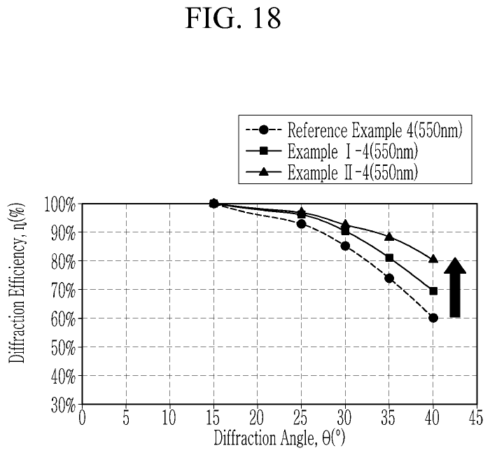

The results are shown in Tables 2 to 7 and FIGS. 13 to 18.

FIGS. 13 to 18 are graphs showing diffraction efficiency according to diffraction angles of diffractive optical elements according to Examples I and II and Reference Example.

TABLE 2

| | | | | Diffraction | | | Diffraction angle | | |
|---|---|---|---|---|---|---|---|---|---|
| | | | Grating | efficiency (η %) | | | (θ, degree) | | |
| | Liquid | Diffraction angle | period | 450 | 550 | 650 | 450 | 550 | 650 |
| | crystal | (θ, degree) | (∧, μm) | nm | nm | nm | nm | nm | nm |
| Example I-1 | A | 15 | 4.25 | 99.67 | 99.19 | 99.28 | 12.2 | 15.0 | 17.8 |
| (2-layered) | | 25 | 2.60 | 96.63 | 95.42 | 91.98 | 20.2 | 25.0 | 30.0 |
| | | 30 | 2.20 | 92.77 | 90.16 | 83.80 | 24.1 | 30.0 | 36.2 |
| | | 35 | 1.92 | 87.50 | 81.16 | 76.00 | 28.0 | 35.0 | 42.7 |
| | | 40 | 1.71 | 81.36 | 70.49 | 60.60 | 31.7 | 40.0 | 49.4 |
| Example II-1 | A | 15 | 6.38 | 99.65 | 99.19 | 99.31 | 12.2 | 15.0 | 17.8 |
| (3-layered) | | 25 | 3.90 | 97.51 | 96.23 | 94.26 | 20.2 | 25.0 | 30.0 |
| | | 30 | 3.30 | 95.14 | 92.18 | 88.25 | 24.1 | 30.0 | 36.2 |
| | | 35 | 2.88 | 91.68 | 88.30 | 79.61 | 28.0 | 35.0 | 42.7 |
| | | 40 | 2.57 | 86.95 | 80.55 | 68.73 | 31.7 | 40.0 | 49.4 |
| Reference | A | 15 | 2.13 | 99.37 | 99.27 | 98.66 | 12.2 | 15.0 | 17.8 |
| Example 1 | | 25 | 1.30 | 94.66 | 92.72 | 88.33 | 20.2 | 25.0 | 30.0 |
| | | 30 | 1.10 | 89.40 | 85.09 | 76.84 | 24.1 | 30.0 | 36.2 |
| | | 35 | 0.96 | 81.58 | 74.50 | 61.17 | 28.0 | 35.0 | 42.7 |
| | | 40 | 0.86 | 71.27 | 60.79 | 43.57 | 31.5 | 40.0 | 49.4 |

TABLE 3

| | | Diffraction | Grating | Diffraction |
|---|---|---|---|---|
| | Liquid | angle | period | efficiency (η %) |
| | crystal | (θ, degree) | (Λ, μm) | (@550 nm) |
| Example I-2 | B | 15 | 4.25 | 99.19 |
| (2-layered) | | 25 | 2.6 | 95.42 |
| | | 30 | 2.2 | 90.16 |
| | | 35 | 1.92 | 81.16 |
| | | 40 | 1.71 | 70.49 |
| Example II-2 | B | 15 | 6.38 | 99.19 |
| (3-layered) | | 25 | 3.90 | 96.23 |
| | | 30 | 3.30 | 92.18 |
| | | 35 | 2.88 | 88.30 |
| | | 40 | 2.57 | 80.55 |
| Reference | B | 15 | 2.13 | 99.27 |
| Example 2 | | 25 | 1.3 | 92.72 |
| | | 30 | 1.1 | 85.09 |
| | | 35 | 0.96 | 74.50 |
| | | 40 | 0.86 | 60.79 |

TABLE 4

| | | Diffraction | Grating | Diffraction |
|---|---|---|---|---|
| | Liquid | angle | period | efficiency (η %) |
| | crystal | (θ, degree) | (Λ, μm) | (@550 nm) |
| Example I-3 | C | 15 | 4.25 | 99.19 |
| (2-layered) | | 25 | 2.6 | 95.42 |
| | | 30 | 2.2 | 90.16 |
| | | 35 | 1.92 | 81.16 |
| | | 40 | 1.71 | 70.49 |
| Example II-3 | C | 15 | 6.38 | 99.19 |
| (3-layered) | | 25 | 3.90 | 96.23 |
| | | 30 | 3.30 | 92.18 |
| | | 35 | 2.88 | 88.30 |
| | | 40 | 2.57 | 80.55 |
| Reference | C | 15 | 2.13 | 99.27 |
| Example 3 | | 25 | 1.3 | 92.72 |
| | | 30 | 1.1 | 85.09 |
| | | 35 | 0.96 | 74.50 |
| | | 40 | 0.86 | 60.79 |

TABLE 5

| | | Diffraction | Grating | Diffraction |
|---|---|---|---|---|
| | Liquid | angle | period | efficiency(η %) |
| | crystal | (θ, degree) | (Λ, μm) | (@550 nm) |
| Example I-4 | D | 15 | 4.25 | 99.19 |
| (2-layered) | | 25 | 2.6 | 95.42 |
| | | 30 | 2.2 | 90.16 |
| | | 35 | 1.92 | 81.16 |
| | | 40 | 1.71 | 70.49 |
| Example II-4 | D | 15 | 6.38 | 99.19 |
| (3-layered) | | 25 | 3.90 | 96.23 |
| | | 30 | 3.30 | 92.18 |
| | | 35 | 2.88 | 88.30 |
| | | 40 | 2.57 | 80.55 |
| Reference | D | 15 | 2.13 | 99.27 |
| Example 4 | | 25 | 1.3 | 92.72 |
| | | 30 | 1.1 | 85.09 |
| | | 35 | 0.96 | 74.50 |
| | | 40 | 0.86 | 60.79 |

Referring to Tables 2 to 5 and FIGS. 13 to 18, the diffractive optical elements according to Examples may realize a high diffraction angle without reducing a grating period and simultaneously, realize high diffraction efficiency at the high diffraction angle. Furthermore, referring to Table 2 and FIGS. 13 to 15, the diffractive optical elements according to Examples exhibit a small diffraction efficiency change depending on a wavelength (450 nm, 550 nm, and 650 nm), for example, relatively high diffraction efficiency of greater than or equal to about 60% at a high diffraction angle of about 40 degrees.

### Simulation II

Optical simulation of the diffractive optical element according to the number of stacked diffractive layers is performed using the FDTD software.

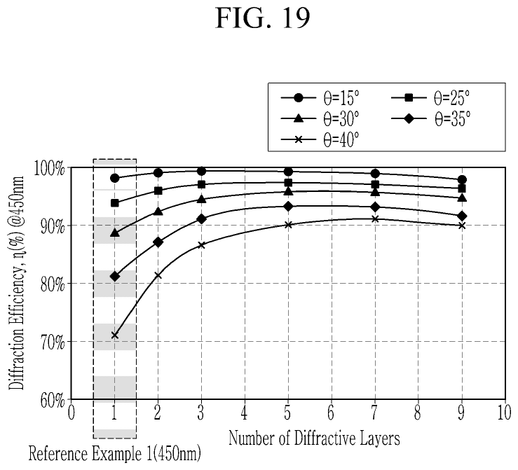

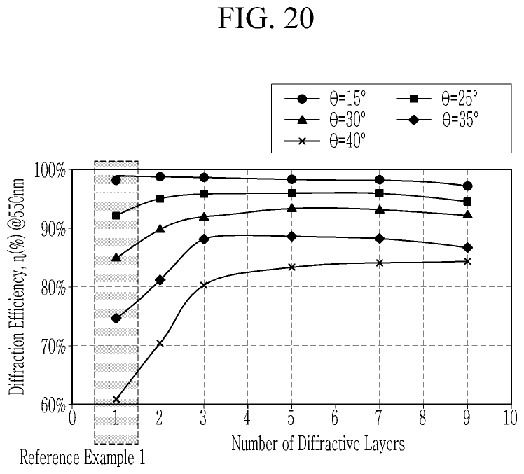

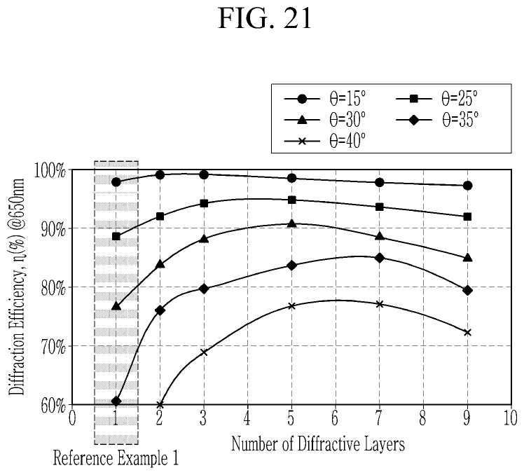

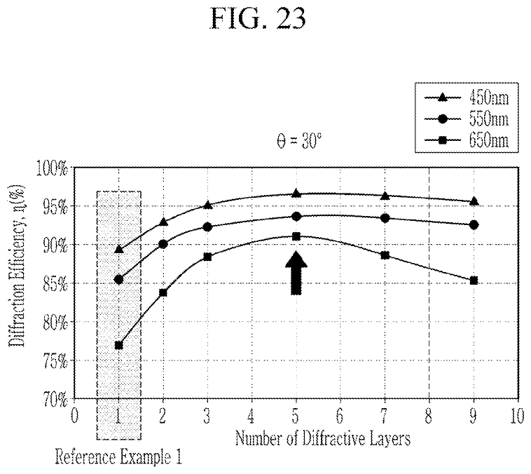

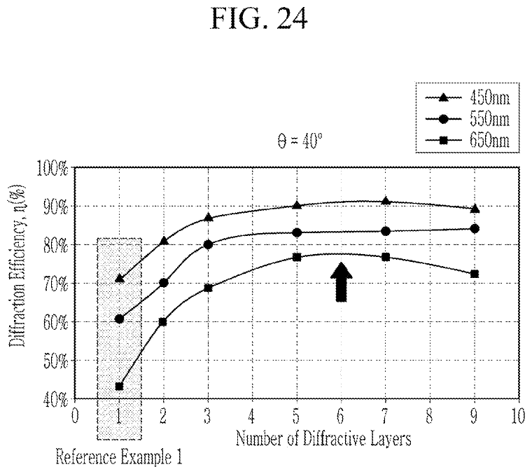

The results are shown in FIGS. 19 to 24.

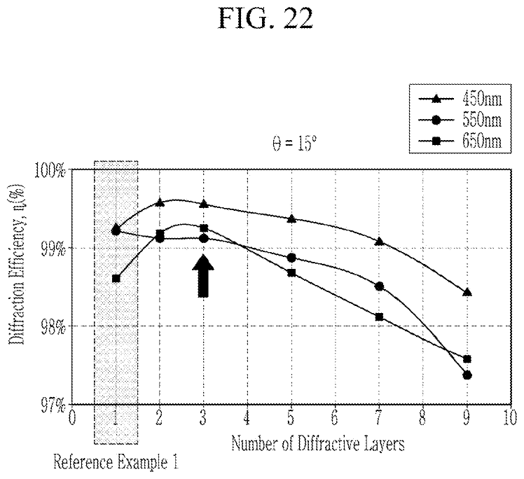

FIGS. 19 to 21 are graphs showing diffraction efficiency according to the diffraction angles and the number of diffractive layers of the diffractive optical elements according to Examples Ito VIII and Reference Example, and FIGS. 22 to 24 are graphs showing diffraction efficiency according to the wavelength and the number of diffractive layers at a predetermined diffraction angle.

Referring to FIGS. 19 to 21, the diffractive optical elements according to Examples I to VIII exhibit higher diffraction efficiency at a high diffraction angle (about 15 degrees to 40 degrees) than that of the diffractive optical element according to Reference Example.

In addition, referring to FIGS. 22 to 24, the optimal number of diffractive layer exhibiting high diffraction efficiency simultaneously in a wide wavelength band (450 nm, 550 nm, and 650 nm) depending on a diffraction angle (θ) differs. Accordingly, the number of diffractive layer may be adjusted to realize a diffractive optical element having a wide wavelength band at a desired diffraction angle.

While this disclosure has been described in connection with what is invention is not limited to the disclosed embodiments. On the contrary, it is intended to cover various modifications and equivalent arrangements included within the spirit and scope of the appended claims.

What is claimed is:

1. A diffractive optical element, comprising:
a plurality of diffractive layers comprising:
adjacent diffractive layers having a plurality of optical axes which change along in-plane rotation directions opposite to each other in a grating period.

2. The diffractive optical element of claim 1, wherein
the in-plane rotation direction is an in-plane clockwise direction or an in-plane counterclockwise direction,
one of the adjacent diffractive layers comprises a plurality of optical axes which change along the in-plane clockwise direction in the grating period, and
a remaining one of the adjacent diffractive layers comprises a plurality of optical axes which change along an in-plane counterclockwise direction in the grating period.

3. The diffractive optical element of claim 1, wherein
the plurality of diffractive layers further comprises:
a first diffractive layer including a plurality of optical axes which change along a first in-plane rotation direction which is one of an in-plane clockwise direction and an in-plane counterclockwise direction in the grating period, and
a second diffractive layer including a plurality of optical axes which change along a second in-plane rotation direction which is a remaining one of the in-plane clockwise direction and the in-plane counterclockwise direction in the grating period,
wherein the first diffractive layer and the second diffractive layer are stacked adjacent to each other.

4. The diffractive optical element of claim 3, wherein
the plurality of diffractive layers further comprises a third diffractive layer including a plurality of optical axes which change along the first in-plane rotation direction in the grating period,
wherein the first diffractive layer, the second diffractive layer, and the third diffractive layer are sequentially stacked adjacent to each other.

5. The diffractive optical element of claim 3, wherein
the first diffractive layer is provided in plural and the second diffractive layer is provided in plural, and
first diffractive layers and the second diffractive layers are alternately stacked with another.

6. The diffractive optical element of claim 3, wherein the grating period of the second diffractive layer are identical to the grating period of the first diffractive layer.

7. The diffractive optical element of claim 3, wherein
the optical axis of the first diffractive layer is constant along the thickness direction,
the optical axis of the second diffractive layer is constant along the thickness direction, and
the optical axis of the first diffractive layer and the optical axis of the second diffractive layer overlapped along the thickness direction of the first diffractive layer and the second diffractive layer are different from each other in at least a portion of each grating period.

8. The diffractive optical element of claim 7, wherein in each grating period, an angle between the optical axis of the first diffractive layer and the optical axis of the second diffractive layer overlapped in the thickness direction of the first diffractive layer and the second diffractive layer change continuously between about 0 degree and about 180 degrees.

9. The diffractive optical element of claim 1, wherein the grating periods of the plurality of diffractive layers are identical to each other.

10. The diffractive optical element of claim 1, wherein each of the plurality of diffractive layers has a grating period of greater than or equal to about 1.7 micrometers.

11. The diffractive optical element of claim 1, wherein each of the plurality of diffractive layers independently comprises an optically anisotropic medium satisfying one of Relationships 1A to 1E:
Δn₁(450 nanometers(nm))<Δn₁(550 nm)≤Δn₁(650 nm) [Relationship 1A]
Δn₁(450 nm)≤Δn₁(550 nm)<Δn₁(650 nm) [Relationship 1B]
Δn₁(450 nm)=Δn₁(550 nm)=Δn₁(650 nm) [Relationship 1C]
Δn₁(450 nm)≥Δn₁(550 nm)>Δn₁(650 nm) [Relationship 1D]
Δn₁(450 nm)>Δn₁(550 nm)≥Δn₁(650 nm) [Relationship 1E]
wherein, in Relationships 1A to 1E,
Δn₁ (450 nanometers) is birefringence of the optically anisotropic medium at a wavelength of 450 nanometers,
Δn₁ (550 nanometers) is birefringence of the optically anisotropic medium at a wavelength of 550 nanometers, and
Δn₁ (650 nanometers) is birefringence of the optically anisotropic medium at a wavelength of 650 nanometers.

12. The diffractive optical element of claim 11, wherein birefringence dispersion according to the wavelength of the optically anisotropic medium satisfies Relationships 2A and 2B:
0.70≤Δn₁(450 nanometers)/Δn₁(550 nanometers)≤1.00 [Relationship 2A]
1.00≤Δn₁(650 nanometers)/Δn₁(550 nanometers)≤1.25 [Relationship 2B]
wherein, in Relationships 2A and 2B,
Δn₁ (450 nanometers) is the birefringence of the optically anisotropic medium at the wavelength of 450 nanometers,
Δn₁ (550 nanometers) is the birefringence of the optically anisotropic medium at the wavelength of 550 nanometers, and
Δn₁ (650 nanometers) is the birefringence of the optically anisotropic medium at the wavelength of 650 nanometers.

13. The diffractive optical element of claim 11, wherein birefringence dispersion according to the wavelength of the optically anisotropic medium satisfies Relationships 2C and 2D:
1.00≤Δn₁(450 nanometers)/Δn₁(550 nanometers)≤1.25 [Relationship 2C]
0.70≤Δn₁(650 nanometers)/Δn₁(550 nanometers)≤1.00 [Relationship 2D]
wherein, in Relationships 2C and 2D,
Δn₁ (450 nanometers) is the birefringence of the optically anisotropic medium at the wavelength of 450 nanometers,
Δn₁ (550 nanometers) is the birefringence of the optically anisotropic medium at the wavelength of 550 nanometers, and
Δn₁ (650 nanometers) is the birefringence of the optically anisotropic medium at the wavelength of 650 nanometers.

14. The diffractive optical element of claim 1, wherein the diffractive optical element satisfies Relationship 3:
θ₂ ×∧₂>θ₁×∧₁ [Relationship 3]
wherein, in Relationship 3,
θ₂ is a diffraction angle of the diffractive optical element at wavelength λ, wherein the wavelength λ is the wavelength of incident light,
∧₂ is a grating period of the diffractive optical element,
θ₁ is a diffraction angle satisfying Relationship AA, and
∧₁ is a grating period satisfying Relationship AA,
$${θ}_{1} = {sin}^{- 1} ( \frac{λ}{{Λ}_{1}} )$$
wherein, in Relationship AA,
θ₁ is the diffraction angle at the wavelength λ,
∧₁ is the grating period, and
λ is the wavelength of the incident light.

15. The diffractive optical element of claim 14, wherein the diffractive optical element satisfies Relationship 4:
θ₂×∧₂=n(θ₁×∧₁) [Relationship 4]
wherein, in Relationship 4,
θ₂ is a diffraction angle of the diffractive optical element at wavelength λ, wherein the wavelength λ is the wavelength of incident light,
∧₂ is a grating period of the diffractive optical element, and
n is a number of diffractive layers of the diffractive optical element and is an integer from 2 to 10.

16. The diffractive optical element of claim 1, wherein a diffraction angle of the diffractive optical element is greater than a diffraction angle of each of the plurality of diffractive layers.

17. The diffractive optical element of claim 1, wherein a maximum diffraction angle of the diffractive optical element satisfying a same diffraction efficiency is greater than the maximum diffraction angle of a single diffractive layer.

18. The diffractive optical element of claim 1, wherein a difference between a maximum diffraction efficiency and a minimum diffraction efficiency at a diffraction angle of greater than about 0 degree and less than or equal to 40 degrees is less than or equal to about 40 percent.

19. The diffractive optical element of claim 1, wherein a diffraction efficiency of the diffractive optical element at a wavelength of 450 nanometers, a diffraction efficiency of the diffractive optical element at a wavelength of 550 nanometers, and a diffraction efficiency of the diffractive optical element at a wavelength of 650 nanometers are each independently about 50 percent to about 100 percent.

20. The diffractive optical element of claim 19, wherein a diffraction angle of the diffractive optical element at a wavelength of 450 nanometers, a diffraction angle of the diffractive optical element at a wavelength of 550 nanometers, and a diffraction angle of the diffractive optical element at a wavelength of 650 nanometers are each independently about 5 degrees to 50 degrees.

21. The diffractive optical element of claim 1, wherein the plurality of diffractive layers comprises two to ten layers.

22. A diffractive optical element, comprising:
a diffractive layer having one or more grating periods,
wherein the diffractive layer comprises a plurality of optical axes which change along an in-plane rotation direction in each grating period, and the diffractive optical element satisfies Relationship 3:
θ₂×∧₂>θ₁×∧₁ [Relationship 3]
wherein, in Relationship 3,
θ₂ is a diffraction angle of the diffractive optical element at wavelength λ, wherein the wavelength λ is the wavelength of incident light,
∧₂ is a grating period of the diffractive optical element,
θ₁ is a diffraction angle satisfying Relationship AA, and
∧₁ is a grating period satisfying Relationship AA,
$${θ}_{1} = {sin}^{- 1} ( \frac{λ}{{Λ}_{1}} )$$
wherein, in Relationship AA,
θ₁ is the diffraction angle at the wavelength λ,
∧₁ is the grating period, and
λ is the wavelength of the incident light.

23. The diffractive optical element of claim 22, wherein
the diffractive layer comprises an optically anisotropic medium, and
an optical axis of the diffractive layer is parallel to a direction of a long axis of the optically anisotropic medium.

24. The diffractive optical element of claim 22, wherein
the diffractive optical element comprises
a first diffractive layer including a plurality of optical axes which change along a first in-plane rotation direction which is one of an in-plane clockwise direction and an in-plane counterclockwise direction in the grating period, and
a second diffractive layer including a plurality of optical axes which change along a second in-plane rotation direction which is a remaining one of the in-plane clockwise direction and the in-plane counterclockwise direction in the grating period.

25. The diffractive optical element of claim 24, further comprising a third diffractive layer, the third diffractive layer including a plurality of optical axes which change along the first in-plane rotation direction in the grating period,
wherein the first diffractive layer, the second diffractive layer, and the third diffractive layer are sequentially stacked adjacent to each other.

26. The diffractive optical element of claim 24, wherein
each of the first diffractive layer and the second diffractive layer is provided in plural, and
the first diffractive layer and the second diffractive layer are alternately stacked.

27. The diffractive optical element of claim 22, wherein the diffractive optical element satisfies Relationship 4:
θ₂×∧₂=n(θ₁×∧₁) [Relationship 4]
wherein, in Relationship 4,
θ₂ is a diffraction angle of the diffractive optical element at wavelength λ, wherein the wavelength λ is the wavelength of incident light,
∧₂ is a grating period of the diffractive optical element, and
n is a number of diffractive layers of the diffractive optical element and is an integer from 2 to 10.

28. The diffractive optical element of claim 1, wherein the diffractive optical element is a lens or a prism.

29. The diffractive optical element of claim 1, wherein the diffractive optical element is a flat diffractive optical element with a constant thickness and curvature.

30. A stacked diffractive optical element in which the diffractive optical element of claim 1 is provided in plural.

31. The stacked diffractive optical element of claim 30, comprising:
a blue diffractive optical element which exhibits a maximum diffraction efficiency in a wavelength range of greater than or equal to about 400 nanometers and less than about 500 nanometers,
a green diffractive optical element which exhibits a maximum diffraction efficiency in a wavelength range of about 500 nanometers to about 600 nanometers, and
a red diffractive optical element which exhibits a maximum diffraction efficiency in a wavelength range of greater than about 600 nanometers and less than or equal to about 700 nanometers.

32. The stacked diffractive optical element of claim 30, further comprising a wavelength selective filter.

33. A device comprising the diffractive optical element of claim 1.

34. A device comprising the diffractive optical element of claim 22.

35. A device comprising the stacked diffractive optical element of claim 30.
